(19) United States
(12) Patent Application Publication
(10) Pub. No.: US 2011/0081639 A1
(43) Pub. Date: Apr. 7, 2011

(54) Daisy Oracle of Love

(76) Inventor: Pedro Jose Lopez Garcia, Duarte, CA (US)

(21) Appl. No.: 12/574,406

(22) Filed: Oct. 6, 2009

(51) Int. Cl. G09B 3/00

(52) U.S. Cl. 434/322

(57) ABSTRACT

An artificial daisy flower with the petals 14-38 being detachable for the purpose of guessing answers. The daisy will have the look and the feel of a real one, having a stem 10 and leaves 11 & 12 like the natural one.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to artificial daisies that have removable petals, specifically to guess the future.

2. Prior Art

Since old times, it is believed that daisies have the power to predict the future, specially referring to love, that is why detaching the petals one by one saying “loves me, loves me not, loves me . . . etc”. With this method we can know if the person we love loves us back.

Not to long ago, I went for a walk in to the country side and when I got to a place where there were many daisies, I picked one up and started detaching the petals one by one. The final result was negative, but I picked another one and then the result was positive. Walking back home I started to thinking of how lucky I was to live in the countryside where I could do pick up flowers from the countryside and take them to my loved one. I thought about the people that have to live in the city where they do not have the privilege to do this. The inconvenience was always there for them, to buy daisies at such an expensive price and for them to die in less than 7 days. Then came to me the idea of creating an artificial daisy of a non-toxic material, with the advantage of being a floral arrangement that will last for ever and that could be utilized by any sex, and the age of a person. The daisy's utility to have detachable petals, recyclable and with the same touch of a real one.

In detail, the daisy will consist of a long stem with petals and at the end of the stem there will be the flower with elongated petals. The flower will have 25 petals, number of which is not always the same for the invented. Real daisies only last up to 7-10 days in the flower base, a problem that the invented one will not face. Un-cut real daisies will close their petals at night, something that the invented one will not do. Natural daisies also vary much in sizes, our invented will be consistent in size making them look uniformed. As well as the petals in them, same shape petal for each. At the moment there is nothing out in the market to compare it with other than the real ones of nature.

3. Objects and Advantages

Several objects and advantages of the present invention are:

(a) Duration: Since the flower is not real, it will not die and it will last for a long period of time.

(b) Relation of Quality to Price: Since these are artificial flowers the advantage of them not dieing on you will help you save money by not having to replace them in case you have the inconvenience of not being able to use them soon. You would be able to use them at any desired time and to give them as gifts to any person.

(c) Allergy Free: Some people are allergic to the pollen found in real daisies therefore they would not have the same problem with these at any time.

(d) Safe for most ages, since the used materials are not toxic older children would be able to use.

(e) After detaching the petals, all parts can be recycled.

(f) Touch and looks like real daisy, this will make it more attractive to the buyer and user.

(g) Multi use: can be used for ornamentation and for guessing

(h) Can be used as an ornament or gifts in parties year round.

Further objects and advantages are to provide a daisy with removable petals for the use of guessing the future of a person as sort of a ritual. This utility is completely different from the real because the real ones only decorate and add a smell to the place where they are located. Not only does this invention guess your future but will also create value to the life of the person using it. The intention of this product is intended to bring good memories to its users, bring positive values and success. Making them think positive to achieve something they want to realize in life, being for the love of a person, success in work, school, etc. . . . The intention is to apply the positive results the daisies will bring to their real life, to create a higher self-esteem, to become stronger in their belief, have confidence, know how to value themselves and appreciate what one has. Not to give up and bring strength that will ultimately make a better life for them. Each daisy will include an instruction sheet explaining all of this in it's packaging.

### SUMMARY

In accordance with the invention a daisy with removable petals for the guessing of someones answer to a question.

### DRAWINGS

### Figures

In the drawings, closely related figures have the same number for the same piece but in different angles (views).

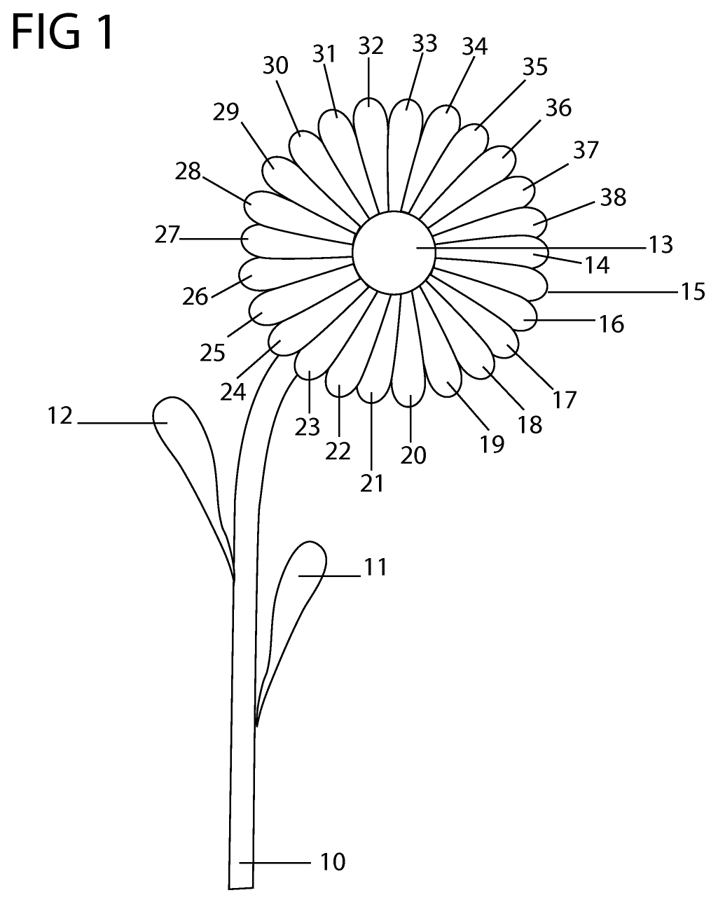

FIG. 1 shows the frontal view of the daisy

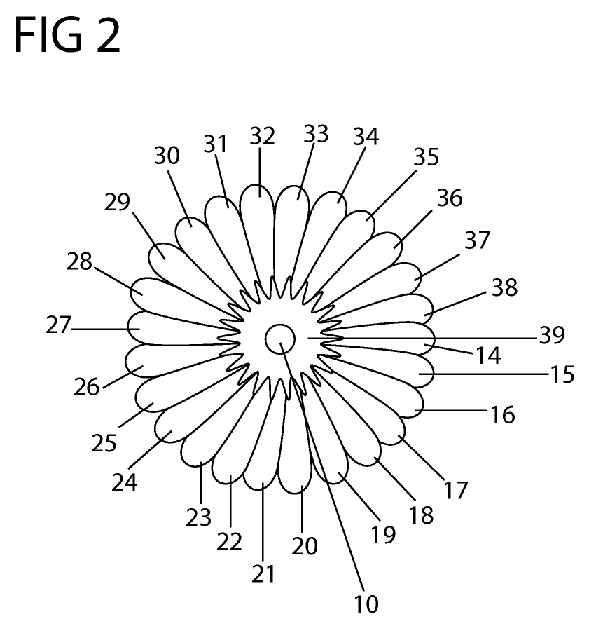

FIG. 2 shows the back of the flower (daisy)

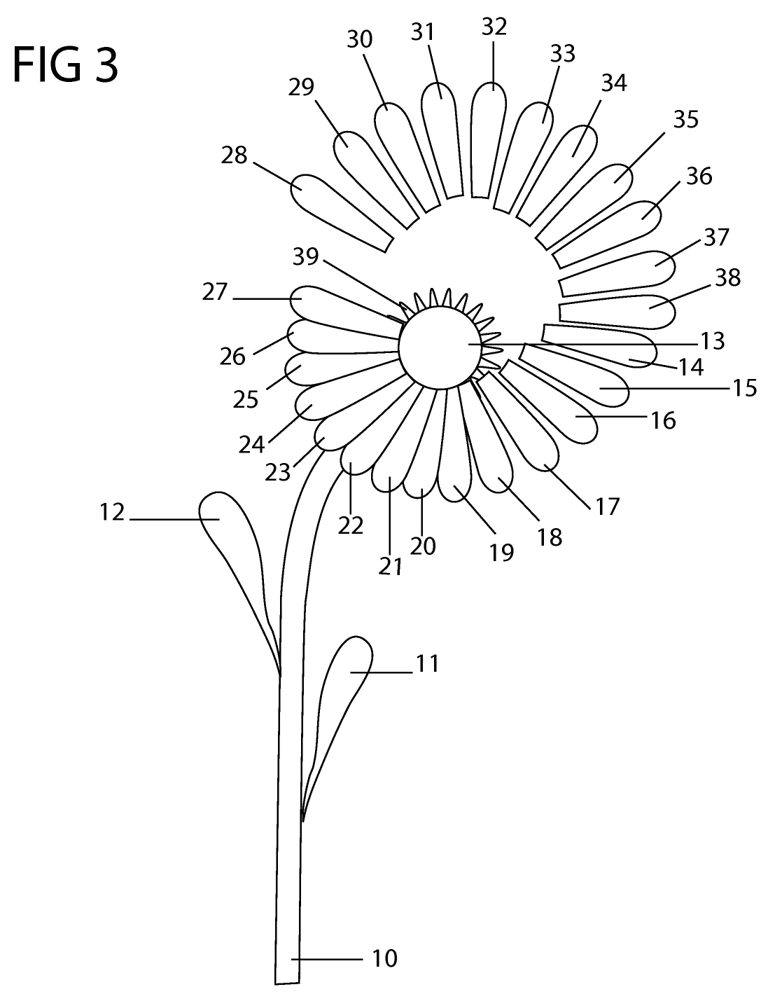

FIG. 3 shows the procedure of the utility, detaching petal by petal

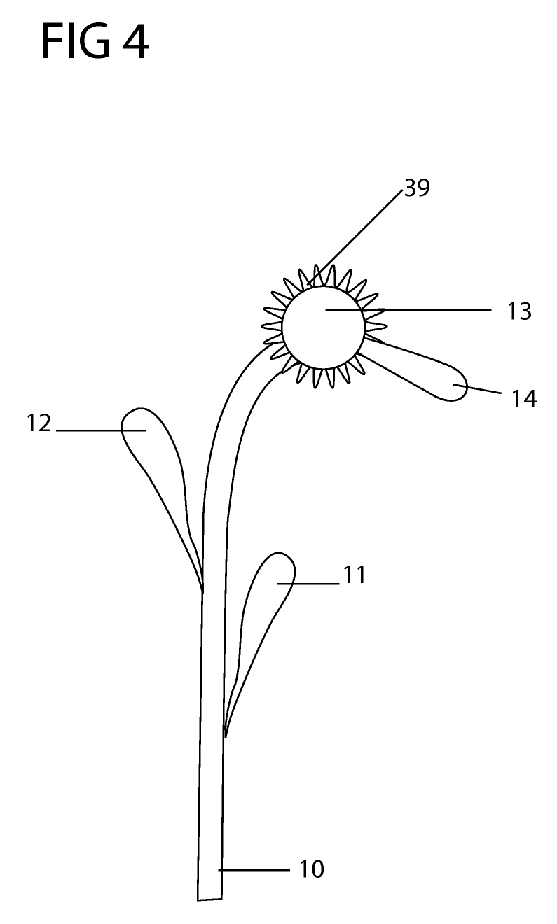

FIG. 4 shows the end of the proceeder, the last petal will give the answer

### REFERENCE NUMERALS

10. Stem

11. Leaf 1

12. Leaf 2

13. Center of Flower

14. Petal 1

15. Petal 2

16. Petal 3

17. Petal 4

18. Petal 5

19. Petal 6

20. Petal 7

21. Petal 8

22. Petal 9

23. Petal 10

24. Petal 11

25. Petal 12

26. Petal 13

27. Petal 14

28. Petal 15

29. Petal 16

30. Petal 17

31. Petal 18

32. Petal 19

33. Petal 20

34. Petal 21

35. Petal 22

36. Petal 23

37. Petal 24

38. Petal 25

39. Back Center (Connection)

### DETAILED DESCRIPTION

### FIGS. 1 & 2

In FIG. 1 the frontal view of a daisy with detachable petals 14-38. Petals are to be perforated so that they can be easily torn off without damaging the rest of the flower. The daisy will be held by the stem 10, the stem 10 will be long enough to be hold comfortably for the operation of detaching the petals 14-38. The stem 10 will have green leaves making the daisy look real, but the leaves will not be detachable. The petals 14-38 will all be the same shape and size, giving it a uniformed look.

FIG. 2 shows the back of the flower only without the stem 10 with leaves 11-12. The back center will be the connection point of the petals 14-38, the center of the flower 13 and the stem 10.

### OPERATION

### FIGS. 3 & 4

FIG. 3 shows the operation process of the utility, pulling off each petal one, starting with petal 14, then petal 15, petal 16, petal 17 and so on until the last petal 38 until it ends with the last petal which gives you the answer to your question as shown in FIG. 4.

### CONCLUSION, RAMIFICATION AND SCOPE

Accordingly, the reader will understand that the daisy oracle of love will help them find answers to questions they have applying the old time method of pulling petals off a daisy. This new product will allow them to give the daisy to others to use it or for themselves.
It will permit the person using it to decorate
It will help someone take fast decisions
It is possible to advertise on the daisies for marketing of businesses
It can be a perfect gift for someone that wants to express their love to others
   Although the description above specifies a procedure, this should not be constructed as limiting the scope of the invention but merely providing illustrations of the preferred presented embodiments of this invention. For example, the invention can have other shapes and construction methods as well as colors and materials.

Thus the scope of the invention should be determined by the appended claims and their legal equivalents, rather than by the examples given.

I claim:

1. A Daisy with detachable petals utilized to remove each petal one by one for guessing an answer like “Yes or No” of a question. The daisy will have from any range of petals 21-25 so that the answers vary. The look of the daisy will be similar but not exactly to the real one of nature. Although the feel of it will be very similar to the real one.
